(19) United States
(12) Patent Application Publication
(10) Pub. No.: US 2011/0256311 A1
(43) Pub. Date: Oct. 20, 2011

(54) METHOD OF COATING A CONTAINER USING A SEMI-PERMANENT COATING COMPOSITION CAPABLE OF BLOCKING ULTRAVIOLET LIGHT

(75) Inventor: Louis Mattos, JR., Douglasville, GA (US)

(73) Assignee: The Coca Cola Company, Atlanta, GA (US)

(21) Appl. No.: 12/760,871

(22) Filed: Apr. 15, 2010

(51) Int. Cl. B05D 3/00; C08K 3/22; C08K 5/3447; C08K 5/07; C08K 5/16; C08K 3/10; C08K 5/101

(52) U.S. Cl. 427/154; 524/403; 524/431; 524/432; 524/408; 524/413; 524/290; 524/359; 524/357; 524/291; 524/186; 524/93

(57) ABSTRACT

The present invention relates to a method of coating a container with a semi-permanent coating composition that can provide protection from exposure to ultraviolet (“UV”) light or light having wavelengths less than or equal to 400 nm. In particular, the present invention relates to a coating composition and a method of application of the coating composition that can be applied, removed from and reapplied to containers that are used for storage of products that are light sensitive. Such products include, but are not limited to, perishables, foods, beverages, pharmaceuticals, and cosmetics.

### FIELD OF THE INVENTION

The present invention relates to a method of coating a container with a semi-permanent coating composition that can provide protection from exposure to ultraviolet (“UV”) light or light having wavelengths less than or equal to 400 nm. In particular, the present invention relates to a coating composition and a method of application of the coating composition that can be applied, removed from and reapplied to containers that are used for storage of products that are light sensitive. Such products include, but are not limited to, perishables, foods, beverages, pharmaceuticals, and cosmetics.

### BACKGROUND OF THE INVENTION

Ultraviolet and visible light are known to degrade natural and synthetic materials in beverages. Specifically, the interaction of UV and visible light (“UV-vis”) with product ingredients (i.e. pigments, vitamins, sweeteners, etc. . . . ) may result in the development of off-note flavors, color changes or loss of nutritional efficacy. Packaging solutions have been developed to mitigate the impact of UV-vis light interactions. Examples include: amber packages, UV additives to PET and aluminum cans. However, there is a need for a clear glass package that provides protection from harmful UV light. Specifically, there is a need for a refillable glass bottle solution.

Further difficulty lies in maintaining UV light protection for refillable glass bottles when the protective coating may be subjected to rough handling and may become scuffed or damaged. It is necessary to remedy such conditions to prevent penetration of UV light into the container and the resulting degradation of the product. Such a compromise of the UV light protection would require a recoating method upon refilling of the glass bottles. However, a glass surface coated with such a protection layer may become unreceptive to further treatment making the adhesion of an additional protective coating extremely difficult to form a secure bond between an existing (possibly damaged) coating, scuffed bare glass, or interfaces of stages in between these states. Therefore, there is proposed in the present invention a refillable glass bottle solution, that of a coating composition that provides protection from harmful UV light and may be removed in the washing cycle.

Previously, only opaque containers such as paperboard containers or metal cans and translucent containers (such as amber colored or dark green glass) offered UV light protection. However, in situations where consumers wish to see and inspect the contents of the bottles, fully opaque or colored containers are less desirable. In fact, market research has shown that for translucent and transparent containers, consumers respond most positively to a clear container than to that of colored materials. Therefore, it is an object of the present invention to provide not only a semi-permanent UV protective glass coating, but also one that is transparent and clear.

### SUMMARY OF THE INVENTION

According to the present invention there is provided a method of coating a container that includes the steps of: applying a transparent coating composition to a container in which the transparent coating composition is composed of a film forming component and an active ingredient that is dispersed throughout the film forming component capable of blocking ultraviolet light; removing the transparent coating composition from the container during a washer cycle, and reapplying the transparent coating composition to the container during each cycle of container use.

Additionally, in the method of coating a container, the transparent coating composition may include a single layer.

In a further embodiment of the method of coating a container, the coating composition may block ultraviolet light having wavelengths less than or equal to 400 nm while providing transmission throughout visible wavelengths.

An additional embodiment of the method of coating a container includes a film forming component that is composed of a polymeric material that includes but is not limited to a polymer, a copolymer, an ionic copolymer, a terpolymer, polyethylene, polyurethane, an olefin, or any combination of these or other similar polymeric materials.

In another embodiment of the method of coating a container, the coating composition contains a film forming component that is composed of a fatty acid material. The fatty acid material employed in this aspect of the invention may include but is not limited to a monobasic fatty acid of 10 to 22 carbon atoms, a salt of a monobasic fatty acid of 10 to 22 carbon atoms, oleic acid, the salt of oleic acid, stearate, an alkalai metal stearate, sodium stearate, zinc stearate, an alkali metal oleate, sodium oleate, and similar materials as well as combinations of such materials.

In a further embodiment of the method of coating a container, the coating composition may contain an active ingredient that includes but is not limited to an inorganic additive, an ultraviolet blocker, an organic additive, a rare earth metal oxide, a pigment, a dye, or any combination of such ingredients.

In yet another embodiment of the method of coating a container, the coating composition may contain an active ingredient that includes but is not limited to Fe₂O₃, FeO, TiO₂, ZnO, CeO₂, oxides of niobium, oxides of hafnium, octyl methoxycinnamate, 4-methylbenzylidene, camphor, avobenzone, oxybenzone, mexoryl, homosalate, padimate O, homosalate, octyl methoxycinnamate, benzophenone, octyl salicylate, phenylbenzimidazole sulfonic acid, octocrylene, a pigment, a dye, or any combination of such ingredients.

An additional embodiment of the method of coating a container includes but is not limited to a container such as a refillable glass bottle, a non-refillable glass bottle, a returnable-refillable PET bottle, a non-refillable PET bottle, as well as combinations of such containers.

In another embodiment of this aspect of the invention, the removal of the transparent coating composition allows for greater than 10% transmittance of ultraviolet light of wavelengths less than or equal to 400 nm.

Another aspect of the current invention contemplates a coating composition for a container including a transparent film forming component capable of removal from the container, and an active ingredient that is dispersed throughout the film forming component capable of blocking ultraviolet light.

In another embodiment of this aspect of the invention, the transparent film forming component includes but is not limited to a polymeric material, a fatty acid material, an olefin, a copolymer, a terpolymer and any combination of these.

In a further embodiment of this aspect of the invention the coating composition includes an active ingredient such as but not limited to an inorganic additive, an ultraviolet blocker, an organic additive, a rare earth metal oxide, a pigment, a dye, and any combination of such materials.

In another embodiment of this aspect of the invention the coating composition includes an active ingredient such as but not limited to FeO, Fe₂O₃, TiO₂, ZnO, CeO₂, oxides of niobium, oxides of hafnium, octyl methoxycinnamate, 4-methylbenzylidene, camphor, avobenzone, oxybenzone, mexoryl, homosalate, padimate O, homosalate, octyl methoxycinnamate, benzophenone, octyl salicylate, phenylbenzimidazole sulfonic acid, octocrylene, a pigment, a dye, and any combination of such ingredients.

In another embodiment of the coating composition the container includes but is not limited to a refillable glass bottle, a non-refillable glass bottle, a returnable-refillable PET bottle, a non-refillable PET bottle, as well as combinations of these containers.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings, in which:

FIG. 1 is a flow chart of one embodiment of the method of coating a container using a semi-permanent coating composition capable of blocking ultraviolet light described in Example 1.

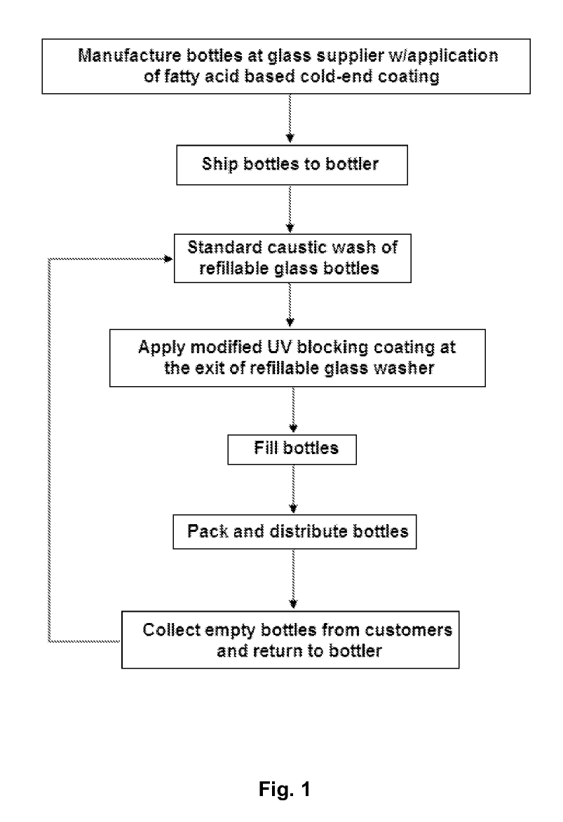

FIG. 2 is a flow chart of another embodiment of the method of coating a container using a semi-permanent coating composition capable of blocking ultraviolet light described in Example 2.

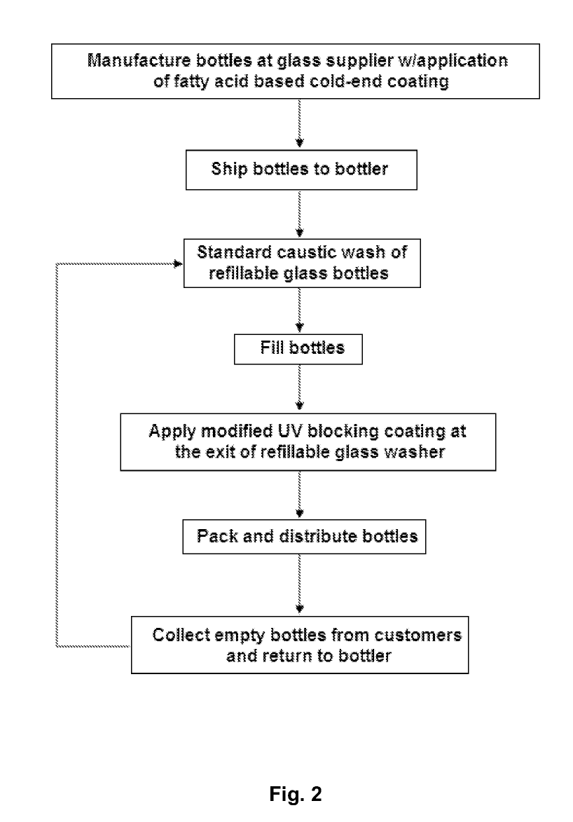

### DETAILED DESCRIPTION

The detailed embodiments of the present invention are disclosed herein. It should be understood, however, that the disclosed embodiments are merely exemplary of the invention, which may be embodied in various forms. Therefore, the details disclosed herein are not to be interpreted as limited, but merely as the basis for the claims and as a basis for teaching one skilled in the art how to make and/or use the invention.

### DEFINITIONS

The term “active ingredient” means a specific compound in a natural or man-made mixture that is responsible for the mixture's activity of blocking and/or absorbing ultraviolet light. Such active ingredients may include but are not limited to inorganic additives, ultraviolet blockers, ultraviolet absorbers, organic additives, rare earth metal oxides, FeO, Fe₂O₃, TiO₂, ZnO, CeO₂, oxides of niobium, oxides of hafnium, octyl methoxycinnamate, 4-methylbenzylidene, camphor, avobenzone, oxybenzone, mexoryl, homosalate, padimate O, homosalate, octyl methoxycinnamate, benzophenone, octyl salicylate, phenylbenzimidazole sulfonic acid, octocrylene, pigments, dyes, and combinations of these and the like.

The terms “apply” and “applying” mean to lay or place, to fix closely or to attach to a container, bottle, can, surface, substrate or the like. In one embodiment, applying refers to the application of a coating 20 um in thickness to a bottle, container or substrate. In another embodiment, the process of applying a coating is in a thickness sufficient to block UV light equal to or less than 400 nm. In a further embodiment, the coating may be applied to a thickness level and particle size level that insures a transparent coating is formed. The coating may be applied by various techniques, including but not limited to spray application, dip coating, sputtering, vapor phase deposition, electrostatic spray, contact coating methods such as sponge coating or brushing, and the like.

As used herein, the terms “block” and “blocking” mean to obstruct or prevent something from passing, as in preventing or obstructing the passage of ultraviolet light. The passage or obstruction of ultraviolet light may be measured as % T or percent transmittance, indicating the percent of ultraviolet light that is allowed to pass through a layer or barrier of material. Such transmittance is related to the absorbance of light and may be measured using ultraviolet-visible spectroscopy. A spectrophotometer may be used to measure the intensity of light passing through a sample (I) and compare it to the intensity of light before it passes through the sample (Iₒ). The ratio I/Iₒ is called the transmittance and is usually expressed as a percentage (% T). In one embodiment of the invention, the ultraviolet absorption or ultraviolet blocking of a bottle or container may have no greater % transmittance (% T) than 1% at wavelengths of 380 nm, 4% at wavelengths of 400 nm, and 45% at wavelengths of 550 nm. In another embodiment of the invention, the UV blocking coated bottle or container has less than 10% transmittance at wavelengths of 380 nm.

The terms “coat” and “coating” mean a covering or layer of solution, substance or material.

As used herein the term “container” may refer to packaging and labeling used to contain, store, and transport products, such as bottles, cans, cartons, etc. Contain may also convey a variety of forms without departing from the spirit and scope of the present invention. A container can be configured as a box, a barrel, a vial, or a tube without departing from the intended scope of the invention. Further, container can be the primary container for the contents thereof, i.e., the contents are in direct contact with the container, or the container can in the form of a secondary container, i.e., a light-protective barrier provided over a primary container that is in direct contact with the contents.

The term “dispersed” used herein refers to a continuous phase distribution of particles throughout a material or medium of a different composition.

The term “fatty acid material” refers to materials composed of carboxylic acids with a long unbranched aliphatic tail (chain), which may be saturated or unsaturated. Fatty acids may be produced by the hydrolysis of the ester linkages in a fat or biological oil, with the removal of glycerol as in oleochemicals. Fatty acid materials may include all acyclic aliphatic carboxylic acids including but not limited to monobasic fatty acids of 10 to 22 carbon atoms, salts of monobasic fatty acids of 10 to 22 carbon atoms, oleic acid, salts of oleic acid, stearate, alkalai metal stearate, sodium stearate, zinc stearate, alkalai metal oleates, sodium oleate, combinations of these and the like.

The term “film forming component” means a material that may form a covering or layer composed of materials including but not limited to polymeric or fatty acid materials. This type of film forming component or agent may leave a pliable cohesive and continuous covering over the surface when applied. Film forming components may include but are not limited to polyvinylpyrrolidone, acrylates, acrylamides, copolymers, polymers, ionic copolymers, terpolyers, polyethylene, polyurethane, olefins, combinations of these and the like.

The term “inorganic additive” refers to compounds that are considered to be of a mineral, not biological, origin. Some carbon-containing compounds are traditionally considered inorganic including but not limited to carbonic acid, carbon monoxide, carbonates, cyanides, cyanates, carbides, and thiocyanates, nitrogen, carbon dioxide, simple oxides of carbon, allotropes of carbon, CeO, FeO, TiO, ZnO, water, oxygen and the like. Many species of inorganic additives are ions. Inorganic ions include but are not limited to metallic, sodium, chloride, and phosphate ions and the like

As used herein the term “organic additive” refers to organic compounds that are a member of a large class of chemical compounds whose molecules contain carbon. Such compounds may contain one or more carbon-hydrogen bonds and are considered to be organic including but not limited to octylmethoxycinnamate (OMC), 4-methylbenzylidene camphor, avobenzone, oxybenzone, homosalate and the like.

As used herein the term “PET” refers to polyethylene terephthalate or poly(ethylene terephthalate), PETE, PET-P, or PETP, which is a thermoplastic polymer resin used in beverage, food and other liquid containers.

The terms “pigment” and “dye” refer to materials that change the color of reflected or transmitted light as the result of wavelength selective absorption. A pigment is often but not necessarily insoluble in the vehicle resulting in a suspension. A dye is often, but not necessarily soluble in its vehicle resulting in a solution. Both pigments and dyes can be colorants depending on the vehicle it is used in. In some cases, a pigment can be manufactured from a dye by precipitating a soluble dye with a metallic salt.

The term “polymeric material” used herein includes but is not limited to polymers, copolymers, ionic copolymers, terpolymers, polyethylene, polyurethane, olefins and combinations of these and the like. Polymers are large molecules composed of repeating structural units typically connected by covalent chemical bonds. Most commonly, the continuously linked backbone of a polymeric material consists mainly of carbon atoms. However, other structures do exist and the meaning here is thus not limited to carbon based materials.

As used herein the terms “reapplying” and “reapply” refer to the act of applying, or laying or placing, or fixing closely or attaching to a container, bottle, surface, substrate, or the like.

The term “refillable” refers to the ability of a bottle or container to be filled following the emptying of the bottle or container's contents. This term may also refer to a subsequent filling of a previously filled bottle or container. The term “non-refillable” refers to the absence of the ability of a container to be filled once its contents have been emptied. The term “returnable-refillable” refers to the ability of a bottle or container to be returned from the consumer back to a bottler, manufacturer, or business in which the bottle or container may be washed and refilled for subsequent use and sale.

The term “removing” refers to the ability to dislocate or move by taking off, lifting, or taking away from an underlying surface, substrate, bottle, container, glass or the like. In one embodiment, a UV blocking coating may be removed from a bottle, container or substrate resulting in a coating free surface in preparation for subsequent recoating of the bottle, container or substrate. In another embodiment of the invention the bottle or container would be subjected to steps which would take away from the surface of the bottle or container to a degree sufficient to allow for bonding between the surface and any subsequently applied coating or layer. In a further embodiment, a surface tension test such as a tilt table or a direct measurement of surface tension of the container coating may be used to determine whether the surface of a container has been adequately prepared to allow for bonding between the surface and any subsequently applied coating or layer. A further embodiment of the invention contemplates that a spectrographic test may be employed to determine the removal of sufficient coating material from the surface of a container to allow for bonding between the surface and any subsequently applied coating or layer. In one embodiment, such a spectrographic test, or tilt table/direct measurement test of surface tension would test for UV light blocking. In one such embodiment, the removal of the transparent coating composition allows for greater than 10% transmittance of ultraviolet light of wavelengths less than or equal to 400 nm.

The term “single layer” as used herein refers to a single thickness of some material covering a surface, substrate, bottle, container, can, or the like.

The term “transparent” means see-through, clear, having the physical property of allowing light to pass through it almost undisturbed, such that one can see through it clearly.

The terms “UV light” and “ultraviolet light” refer to light in the ultraviolet part of the energy spectrum. UV or ultraviolet light is electromagnetic radiation with a wavelength shorter than that of visible light, in the range of 10 nm to 400 nm, and energies of 3 eV to 124 eV.

The term “washer cycle” refers to the repeating event or cyclic process of washing of containers such as refillable bottles, cans, crates, etc. in a washing machine or device.

The coating system in accordance with the present invention provides a transparent, hard, dry-to-the-touch coating which may be applied in thick or thin coatings to durable surfaces. The coating system provides protection from UV light as well as protection from many solvent-based products, such as, inks, stains, alcohol, beverages, liquid soaps and paints. The coating system also protects underlying surfaces from scratching, abrading and/or discoloration.

A proposed embodiment of the current invention includes a semi-permanent glass coating that is designed to provide UV protection during standard storage and distribution of a product. To ensure continuous UV protection/efficacy throughout the life of a refillable glass bottle, the coating is removed during the standard, refillable glass washer cycle (high-temperature caustic soda) and reapplied during each cycle of use. Alternatively, the light blocking performance of the coating may be extended into the visible light range through the addition of pigments selected to block specific wavelengths of light (i.e. a black coating, a blue coating, and a Georgia Green coating).

A preferred aspect of the proposed embodiment includes a coating for glass bottles capable of absorbing/blocking 90% of the UV radiation less than or equal to 400 nm. The coating contains a film forming component, including but not limited to the following families: 1) Polymeric (ie: polyethylene, polyurethane); and 2) Fatty acids (ie: oleic acid, stearate). Additionally, the coating includes active ingredients which may be used individually or in combination to achieve the desired effect. Such active ingredients may include but is not limited to: 1) Inorganic additives (ie: CeO₂, FeO, Fe₂O₃, TiO, ZnO); 2) Organic additives (ie: octylmethoxycinnamate (OMC), 4-methylbenzylidene, camphor, avobenzone, oxybenzone, and homosalate); and 3) Pigments and/or dyes.

The coating is considered semi-permanent and is designed to provide the desired UV protection during standard storage and distribution of the product. However, to ensure continuous protection/efficacy throughout the life of the refillable glass bottle, the coating is removed during the standard, refillable glass washer cycle (high-temperature caustic soda) and reapplied during each cycle of use.

Another aspect of this invention is the cost savings to the consumer and to the bottler, manufacturer or business that results from the unitary method of applying, removing (or washing off) and reapplying a UV blocking coating to a container or bottle. Such a unified method of coating, washing/removing the coating and recoating/refilling bottles and containers is cost efficient when contemplated as a single cyclical process. Further cost savings reside in the ability to integrate such a method into current bottling and manufacturing assembly configurations with minimal mechanical alteration.

Additional cost savings of this aspect of the invention include the ability to introduce light sensitive products into the marketplace in refillable bottles and a reduction in the amount of preservatives used. Additionally, when used with PET containers, the invention may allow for the use of larger, more cost efficient batches of standard resins by eliminating the need for toll manufacturing of specialty resins with UV blockers.

Two embodiments of this protective coating removal and reapplication method are given in the following examples:

### Example 1

1) Manufacture bottles at glass supplier with application of fatty acid based cold-end coating;
2) Ship bottles to bottler;
3) Standard caustic wash of refillable glass bottles;
4) Apply modified UV blocking coating at the exit of refillable glass washer;
5) Fill bottles;
6) Pack and distribute bottles;
7) Collect empty bottles from customers and return to bottler; and
8) Repeat steps 3 through 8.

### Example 2

1) Manufacture bottles at glass supplier with application of fatty acid based cold-end coating;
2) Ship bottles to bottler;
3) Standard caustic wash of refillable glass bottles;
4) Fill bottles;
5) Apply modified UV blocking coating using on-line spray application system;
6) Pack and distribute bottles;
7) Collect empty bottles from customers and return to bottler; and
8) Repeat steps 3 through 8.

Alternatively, the light blocking performance of the coating may be extended into the visible light range (wavelengths >400 nm) through the addition of pigments or dyes selected to block specific wavelengths of light (i.e. a black coating, a blue coating, a Georgia Green coating).

In another embodiment of the current invention, the coating may be applied to a returnable-refillable PET (polyethylene terephthalate, or ref-PET) bottle.

In one embodiment of the invention, the coating may be applied to a non-refillable glass bottle.

In a further embodiment of the invention, the coating may be applied to a non-refillable PET bottle.

In another embodiment of the current invention, the UV protective coating may be applied to a container, and may be removed during the standard, refillable glass washer cycle (high-temperature caustic soda) and reapplied during each cycle of use.

We claim:

1. A method of coating a container comprising the steps of:
applying a transparent coating composition to a container wherein the transparent coating composition comprises a film forming component and an active ingredient that is dispersed throughout the film forming component capable of blocking ultraviolet light;
removing the transparent coating composition from the container during a washer cycle; and
reapplying the transparent coating composition to the container during each cycle of container use.

2. The method of claim 1 wherein the transparent coating composition further comprises a single layer.

3. The method of claim 1 wherein the transparent coating composition blocks ultraviolet light having wavelengths less than or equal to 400 nm while providing transmission throughout visible wavelengths.

4. The method of claim 1 wherein the film forming component comprises a polymeric material.

5. The method of claim 4 wherein the polymeric material is selected from the group consisting of a polymer, a copolymer, an ionic copolymer, a terpolymer, polyethylene, polyurethane, an olefin, and any combination thereof.

6. The method of claim 1, 4 or 5 wherein the film forming component further comprises a fatty acid material.

7. The method of claim 6 wherein the fatty acid material is selected from the group consisting of a monobasic fatty acid of 10 to 22 carbon atoms, a salt of a monobasic fatty acid of 10 to 22 carbon atoms, oleic acid, the salt of oleic acid, stearate, an alkalai metal stearate, sodium stearate, zinc stearate, an alkali metal oleate, sodium oleate, and any combination thereof.

8. The method of claim 1 wherein the active ingredient is selected from the group consisting of an inorganic additive, an ultraviolet blocker, an ultraviolet absorber, an organic additive, a rare earth metal oxide, a pigment, a dye, and any combination thereof.

9. The method of claim 1 wherein the active ingredient is selected from the group consisting of FeO, Fe₂O₃, TiO₂, ZnO, CeO₂, oxides of niobium, oxides of hafnium, octyl methoxycinnamate, 4-methylbenzylidene, camphor, avobenzone, oxybenzone, mexoryl, homosalate, padimate O, homosalate, octyl methoxycinnamate, benzophenone, octyl salicylate, phenylbenzimidazole sulfonic acid, octocrylene, a pigment, a dye, and any combination thereof.

10. The method of claim 1 wherein the container is selected from the group consisting of a refillable glass bottle, a non-refillable glass bottle, a returnable-refillable PET bottle, a non-refillable PET bottle, and any combination thereof.

11. The method of claim 1 wherein the removal of the transparent coating composition allows for greater than 10% transmittance of ultraviolet light of wavelengths less than or equal to 400 nm.

12. A coating composition for a container comprising:
a transparent film forming component capable of removal from the container; and an active ingredient that is dispersed throughout the film forming component capable of blocking ultraviolet light.

13. The coating composition of claim 12 wherein the transparent film forming component comprises a material selected from the group consisting of a polymeric material, a fatty acid material, an olefin, a copolymer, a terpolymer and any combination thereof.

14. The coating composition of claim 12 wherein the active ingredient is selected from the group consisting of an inorganic additive, an ultraviolet blocker, an ultraviolet absorber, an organic additive, a rare earth metal oxide, FeO, Fe₂O₃, TiO₂, ZnO, CeO₂, oxides of niobium, oxides of hafnium, octyl methoxycinnamate, 4-methylbenzylidene, camphor, avobenzone, oxybenzone, mexoryl, homosalate, padimate O, homosalate, octyl methoxycinnamate, benzophenone, octyl salicylate, phenylbenzimidazole sulfonic acid, octocrylene, a pigment, a dye, and any combination thereof.

15. The coating composition of claim 12 wherein the container is selected from the group consisting of a refillable glass bottle, a non-refillable glass bottle, a returnable-refillable PET bottle, and a non-refillable PET bottle.
